(19) United States
(12) Patent Application Publication
(10) Pub. No.: US 2024/0111587 A1
(43) Pub. Date: Apr. 4, 2024

(54) CIRCUITRY TO PERFORM PARTIAL DECOMPRESSION OPERATIONS

(71) Applicant: Intel Corporation, Santa Clara, CA (US)

(72) Inventors: Marian HORGAN, Cork (IE); Mateusz POLROLA, Lodz (PL); Fei Z. WANG, Shannon (IE); John J. BROWNE, Limerick (IE); Laurent COQUEREL, Limerick (IE)

(21) Appl. No.: 18/526,910

(22) Filed: Dec. 1, 2023

Related U.S. Application Data
(60) Provisional application No. 63/522,856, filed on Jun. 23, 2023.

(51) Int. Cl. G06F 9/50; G06F 9/54

(52) U.S. Cl. CPC G06F 9/5027; G06F 9/547

(57) ABSTRACT

Examples described herein relate to an accelerator that includes an interface and circuitry coupled to the interface. In some examples, the circuitry is configured to access compressed data, decompress the compressed data, and output the decompressed data based on a call to an application programming interface (API). In some examples, based on a first call to the API having first values, the circuitry is to decompress at least a subset of the data and output at least one strict subset of the decompressed data. In some examples, based on a second call to the API having second values, the circuitry is to decompress an entirety of the data and output the decompressed data.

### RELATED APPLICATION

This application claims the benefit of priority to U.S. Provisional Application No. 63/522,856, filed Jun. 23, 2023. The entire contents of that application are incorporated by reference.

### DESCRIPTION

In computing platforms, central processing units (CPUs) can offload certain operations to accelerator devices in order to free-up CPU cycles for other uses. Accelerator devices (e.g., field programmable gate arrays (FPGAs)) can include cryptography accelerators, graphics accelerators, and/or compression accelerators capable of accelerating the execution of a set of operations in a workload (e.g., processes, applications, services, etc.).

### BRIEF DESCRIPTION OF THE DRAWINGS

FIG. 1 depicts a prior art example of decompression operations.

FIG. 2 shows an example of a requester requesting data decompression based on a configuration.

FIG. 3 shows that partial decompressed data is returned at the start of a destination buffer.

FIG. 4 shows an example decompression circuitry.

FIG. 5 depicts an example accelerator circuitry that can include decompression circuitry.

FIG. 6 depicts an example system.

FIG. 7 depicts an example process of reporting a flag or error code.

FIG. 8 depicts an example of frame formats.

FIG. 9A depicts an example process.

FIG. 9B depicts an example process.

FIG. 10 depicts an example computing system.

### DETAILED DESCRIPTION

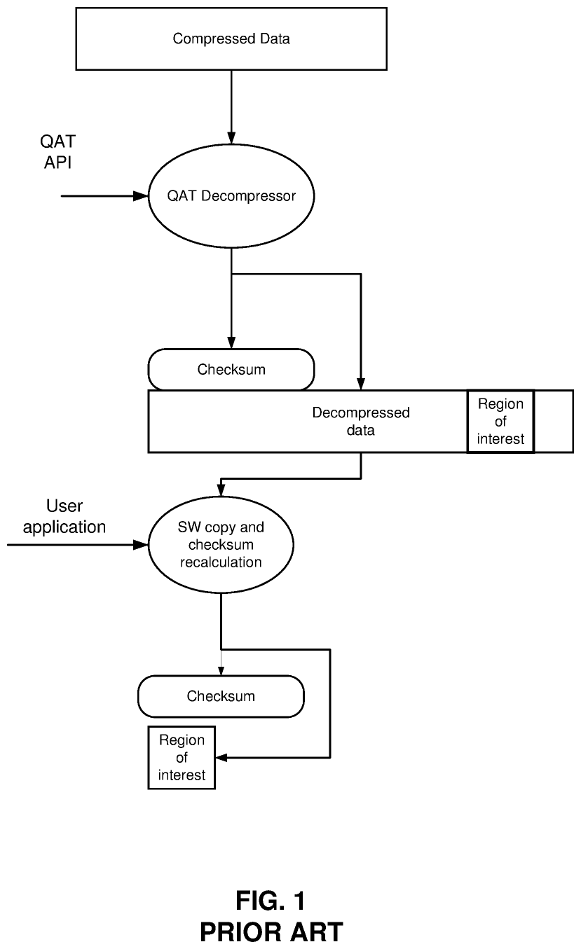

Intel® QuickAssist Technology (QAT) is an accelerator device that can perform decompression of data at the request of a processor. FIG. 1 depicts a prior art example of decompression operations by the QAT. During operation of QAT, a source buffer can be allocated in dynamic random access memory (DRAM) that can store compressed data. The QAT can perform a decompression operation on data based on a data compression length and generate clear text data. Reference to clear text can refer to decompressed data. The QAT can generate a checksum value on the clear text data for a data integrity check. The QAT can store clear text data and checksum into a buffer for access by a user, requester processor, or processor-executed process. In some cases, post processing and a data integrity check on the decompressed data is performed by processor-executed software.

However, in some cases, a subset of the decompressed data can be accessed by the user, requester processor, or processor-executed process. In such cases, transferring an entirety of the decompressed data to a destination buffer can increase time to make decompressed data available, over utilize memory, and over utilize device interface bandwidth.

Various examples provide a decompressor circuitry that, based on a configuration, can decompress data, generate an integrity check value on the entirety of data or the strict subset of the data, and output the entirety of decompressed data or the strict subset of the decompressed data and associated integrity check value to the buffer in memory. A requester (e.g., application, virtual machine, container, microservice, thread, process, administrator, or others) can provide the configuration to request an entirety or one or more portions of the data be decompressed. The configuration can be based on a call to an application programming interface (API) with specific parameters. Parameters can include one or more of: partial decompress flag (e.g., yes/no), partial data length (e.g., length of decompressed data (e.g., bytes)), partial offset (e.g., offset from a start of destination buffer to start of decompressed data in destination buffer), or partial checksum (e.g., apply checksum flag (e.g., Cyclic Redundancy Check (CRC) or quality of service) on partial decompressed data region or on entire decompressed data). Use of an API to offload decompression operations can avoid or reduce decompression operations by requester 200 or the processor that executes requester 200. Decompression operations can be performed as lookaside operations that are asynchronous with other operations of requester 200 and decompression circuitry 250 can receive callbacks from requester 200 or issue callbacks to requester 200 concerning status (e.g., completed, ongoing, failure, error, or others) of requested decompression operations based on configuration 202.

The decompressor circuitry can merely store a decompressed strict subset of the data and generate an associated data integrity value on the decompressed strict subset of the data. Device interface bandwidth utilization can be reduced as less decompressed data may be transferred over the device interface. Memory utilization can be decreased as a size of a destination buffer that stores decompressed data can be reduced. Post-processing of a strict subset of decompressed data by a processor can be reduced where the decompressor circuitry generated the integrity checksum.

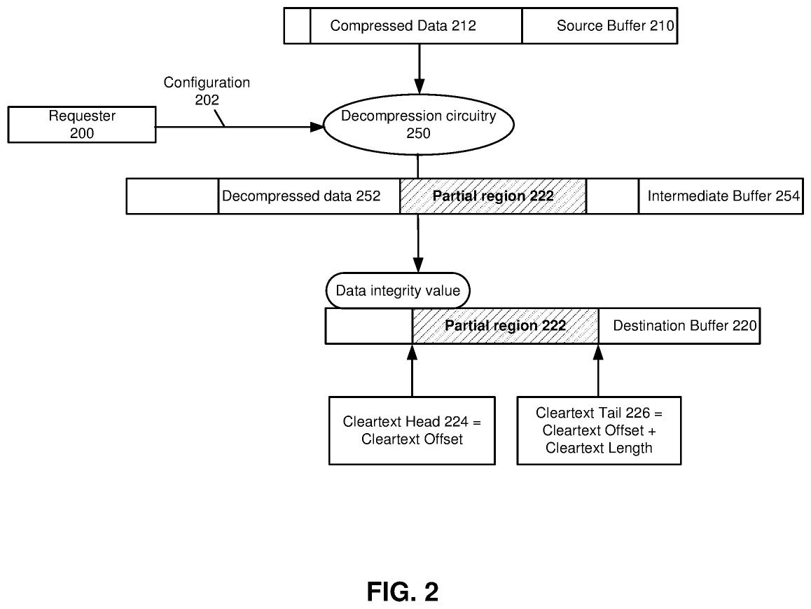

FIG. 2 shows an example of a requester requesting data decompression based on a configuration. In some examples, requester 200 (e.g., application, virtual machine, container, process, microservice, or other software or circuitry) can issue configuration 202 to indicate whether decompression circuitry 250 is to perform a full or partial data decompression operation. Configuration 202 can include one or more of: a flag or command of whether decompression circuitry 250 is to store full or partial data decompressed data, a partial length field that indicates a length of decompressed data 222 that is to be stored in destination buffer 220 for access by requester 220, or partial offset field that indicates an offset from a start of destination buffer 220 to start copying or storing decompressed stream data 222. For example, configuration 202 can specify an offset to a start of compressed data 212 that corresponds to a start of a region of interest in compressed data 212 to decompress as well as a length of compressed data 212 to decompress.

Decompression circuitry 250 can decompress input data 212 from source buffer 210 and monitor the produced decompressed data 252 (e.g., cleartext) to determine what of decompressed data 252 is to be copied to destination buffer 220 as partial region (e.g., clear text) 222. Partial region 222 can represent a strict subset or less than an entirety of decompressed data 252 generated by decompression circuitry 250. Once the partial head (offset) from start of decompressed data has been reached, decompression circuitry 250 or a firmware executed by decompression circuitry 250 can copy decompressed data from intermediate buffer 254 to destination buffer 220, and then monitor if the partial region has been completely written to destination buffer 220 based on a comparison of current cleartext produced bytes and a sum of the offset of partial decompressed data and length of partial decompressed data. Decompression circuitry 250 can stop copying decompressed data to destination buffer 220 after reaching the sum of offset 224 of decompressed data from a start of buffer 220 and tail location 226 of decompressed data (e.g., cleartext tail). Clear text head location 224 can be in units of bytes or bits and represent an offset from a start of destination buffer 220. Cleartext tail location 226 can be in units of bytes or bits and represent an offset from a start of destination buffer 220.

In some examples, configuration 202 can cause decompression circuitry 250 to stop decompressing data 212 after generating partial region 222 and potentially save power and cycles of decompression circuitry 250 after generating partial region 222.

Based on configuration 202, decompression circuitry 250 can generate a data integrity value (e.g., checksum or CRC value) merely on partial region 222, and not on an entirety of decompressed data 252, and store the data integrity value into destination buffer 220, a firmware response to requester 200, or another memory or register location. Data integrity value can represent a data integrity value of partial region 222 based on a flag or command of whether decompression circuitry 250 is to store full or partial decompressed data in configuration 202. Decompression circuitry 250 can be implemented by one or more of: one or more processors; one or more programmable packet processing pipelines; one or more accelerators; one or more hardware queue managers (HQM), one or more application specific integrated circuits (ASICs); one or more field programmable gate arrays (FPGAs); one or more graphics processing units (GPUs); one or more memory devices; one or more storage devices; one or more interconnects; or other circuitry.

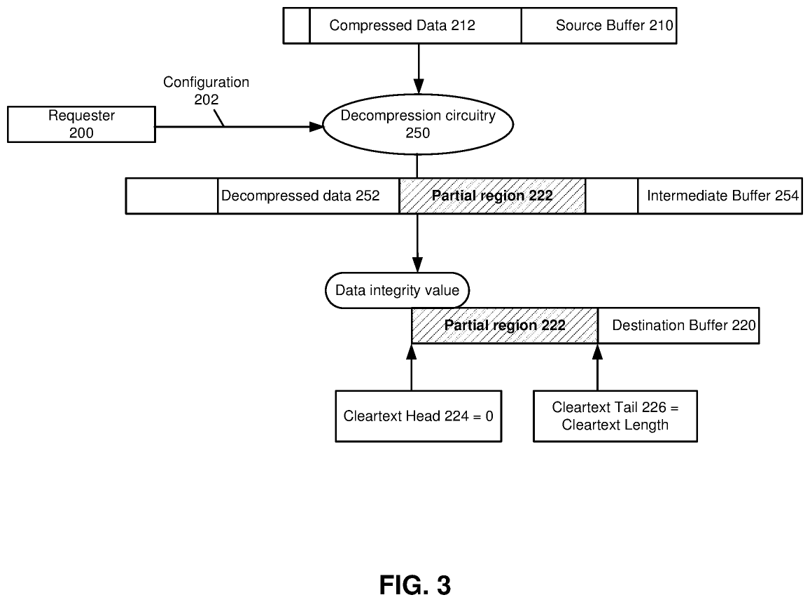

FIG. 3 shows that partial decompressed data is returned at the start of a destination buffer. In this example, decompression circuitry 250 stores partial region 222 is stored at a start of destination buffer 220 by setting head 224 value to 0. This configuration can reduce memory or storage space allocated for destination buffer 220.

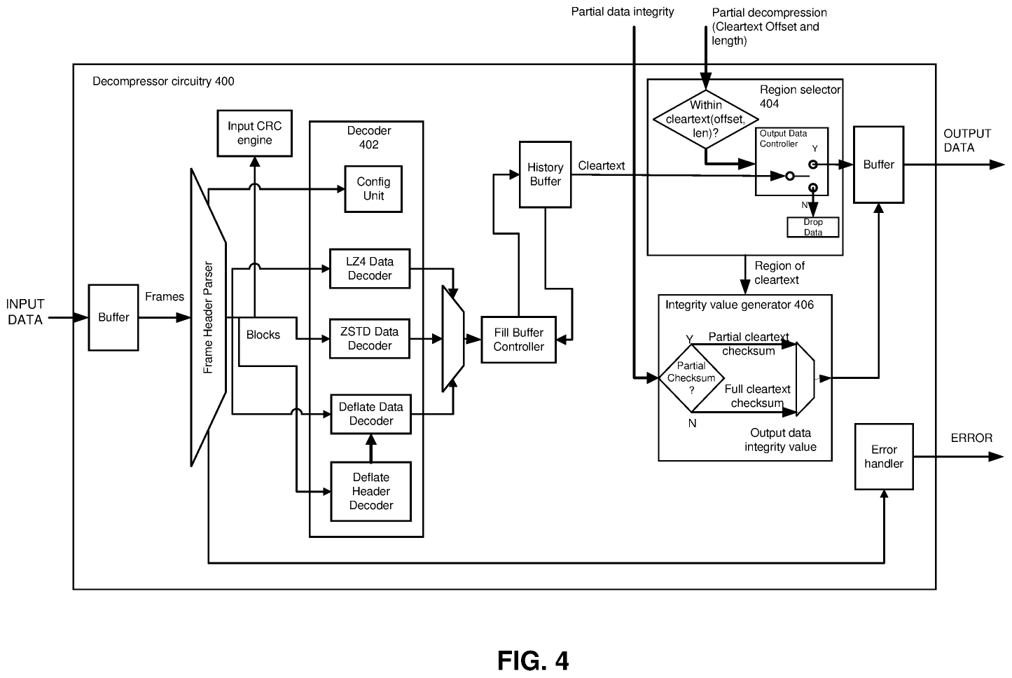

FIG. 4 shows an example decompression circuitry. Input data can include compressed data. In some cases, data can be compressed using lossless or lossy compression schemes. For example, data can be compressed according to schemes including at least Lempel Ziv (LZ) family of compression schemes including LZ4, Zstandard (ZSTD), XP10, DEFLATE, and Snappy standards and derivatives, among others.

Decompression can be applied to compressed data used for large datasets, and also used for deep learning, where data is used at least by: compressed file systems such as Hadoop or Hadoop Distributed File System (HDFS), storage solutions including Ceph, MapReduce which uses HDFS, or Apache Sparc data. Decompressed data can be encrypted by a cryptographic circuitry and stored in encrypted format in memory or storage or transmitted in one or more packets. Decrypted data can be utilized for packet forwarding decisions, in some examples.

For example, a process or requester can provide a configurations or call an API to the accelerator that specifies whether output of partial or full decrypted data is requested. Decompressor circuitry 400 can decompress input data (e.g., compressed data) and selectively output decompressed data or a strict subset of the decompressed data to a destination buffer in memory. Based on the partial decompression flag not being set, region selector 404 can store an entirety of decompressed data into the destination buffer. When the partial decompression flag is set, region selector 404 can determine if a segment of cleartext output from decoder is within a partial region, that is to be stored in the destination buffer as output data. The partial decompression flag can identify the partial region by specification of an offset from a start of decompressed data in a destination buffer and length of the decompressed data including and after the offset. Region selector 404 can store decompressed data between the partial offset and up to the length and drop decompressed data before the partial offset and drop decompressed data after the length from the partial offset and not store such dropped decompressed data to the destination buffer. Region selector 404 can stop outputting decompressed data once partial offset to partial length is output.

Based on the partial decompression flag being set, or a separate indicator to compute partial data integrity value on the partial region, integrity value generator 406 can generate a data integrity value (e.g., checksum or CRC value) for the partial region of the decompressed data. Based on the partial decompression flag not being set, or a separate indicator to compute partial data integrity value on the partial region, integrity value generator 406 can generate a data integrity value (e.g., checksum or CRC value) for the partial region of the decompressed data. The computed data integrity value can be compared against an expected data integrity value by an application or other process to verify data integrity prior to processing the data or encrypting or decrypting the data. Output data can include cleartext, input byte count (IBC) (e.g., number of bytes that were decompressed), output byte count (OBC) (e.g., number of bytes in decompressed data), checksum, data integrity values (e.g., checksum or CRC values), and others.

Note that while examples are described with respect to decompression, examples can apply to decryption, a decryption and decompression sequence, encryption, or other operations. For example, storage of partially decrypted data or a strict subset of decrypted data can be performed based on a call to an API. For example, storage of partially encrypted data or a strict subset of encrypted data can be performed based on a call to an API.

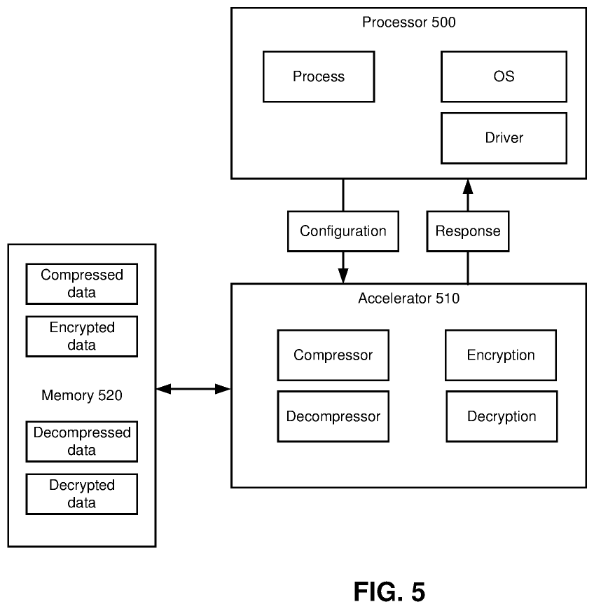

FIG. 5 depicts an example system. Processor 500 (e.g., CPU or GPU) can execute a process that requests compression, decompression, encryption, or decryption operations to be performed. Operating system (OS) or driver can cause accelerator circuitry 510 to perform the operations based on calls by a process to an API, as described herein. Accelerator circuitry 510 can perform offloaded operations from processor 500, but accelerator circuitry 510 does not execute CPU or GPU instructions. Accelerator circuitry 510 can perform one or more of: compression, decompression, encryption, decryption, or others on data stored in memory 520 based on configuration from processor 500 (e.g., a process, OS, or driver) and provide processed data (e.g., compressed data, decompressed data, encrypted data, or decrypted data) to memory 520 or other device for storage. Processor 500, accelerator circuitry 510, and memory 520 can communicate based on communication standards or proprietary interfaces.

In some examples, accelerator circuitry 510 can be implemented as part of a network interface device, where a network interface device can include one or more of: a network interface controller (NIC), a remote direct memory access (RDMA)-enabled NIC, SmartNIC, router, switch, forwarding element, infrastructure processing unit (IPU), data processing unit (DPU), edge processing unit (EPU), or Amazon Web Services (AWS) Nitro Card. An edge processing unit (EPU) can include a network interface device that utilizes processors and accelerators (e.g., digital signal processors (DSPs), signal processors, or wireless specific accelerators for Virtualized radio access networks (vRANs), cryptographic operations, compression/decompression, and so forth). A Nitro Card can include various circuitry to perform compression, decompression, encryption, or decryption operations as well as circuitry to perform input/output (I/O) operations.

In some examples, accelerator circuitry 510 can be implemented as part of a system-on-a-chip (SoC). Various examples of accelerator circuitry 510 can be implemented as a discrete device, in a die, in a chip, on a die or chip mounted to a circuit board, in a package, or between multiple packages, in a server, in a CPU socket, or among multiple servers. Processor 500 can access accelerator circuitry 510 or memory 520 by die-to-die communications; chipset-to-chipset communications; circuit board-to-circuit board communications; package-to-package communications; and/or server-to-server communications. Die-to-die communications can utilize Embedded Multi-Die Interconnect Bridge (EMIB) or an interposer. Components of FIG. 5 (e.g., processor 500, accelerator 510, or memory 520) can be enclosed in one or more semiconductor packages. A semiconductor package can include metal, plastic, glass, and/or ceramic casing that encompass and provide communications within or among one or more semiconductor devices or integrated circuits.

In some cases, a data compression operation on data can generate compressed data that, when decompressed by a decompression circuitry, does not generate the same data as that which was compressed. Detection of such conditions can identify data that is not properly compressed and decompressed and identify potential corruption caused by hardware or system errors and can assist with improving data integrity of decompression and improving accuracy of the decompression operation on data. For a given decompression request, decompression circuitry can return a response that includes decompression job states or status, the data length consumed and produced by decompressor circuitry, and data integrity value computed on the cleartext.

In some cases, data integrity checking operations on the cleartext can be performed by a processor-executed application to determine if the decompressed data is correct by generating a second data integrity value and comparing the second data integrity value against the data integrity value provided with the compressed data frame or block. In addition, to validate the cleartext, the application parses the compressed data frame to identify data integrity value and data length and determine compressed frame format. Validation of cleartext by the application can reduce application performance and utilize processor cycles. In addition, the application developer is to have knowledge of compressed data format to locate the data integrity value in frames of various compressed data formats (e.g., Deflate, LZ4, ZSTD, etc.).

Various examples include a decompression circuitry that includes circuitry that can perform decompression and verify (DCnV) operations on input compressed data and output decompressed data. A request to the decompression circuitry can provide a configuration in a call to an API that requests performance by the decompression circuitry of DCnV on particular data in a source buffer and indicates in a flag or error code whether DCnV operations passed or failed (e.g., decompressed data matches data that was previously compressed). The flag or error code can be provided to the requester to indicate if the decompressor circuitry's output data is verified. Examples can verify end-to-end data integrity during decompression operations.

Decompressor circuitry can identify a compressed frame format by reading a frame's frame format code, locating a data integrity value or compression format specific values (e.g., decompression data length, compressed data length) in a frame of a pre-defined compression format (e.g., industry standard), and comparing the data integrity value read from a compressed frame with the data integrity value and compression format specific values (e.g., decompression data length, compressed data length) generated by the decompressor circuitry. If the data integrity values or compression format specific values (e.g., decompression data length, compressed data length) do not match, then a data integrity flag or error code can be set in a decompressor circuitry response to a requester by decompressor. When the requester detects a flag or error code indicating mismatch of data integrity values, the cleartext date integrity has been failed verification by the decompressor circuitry. The decompressor circuitry's compression operation or the compressed data can be identified as having an error.

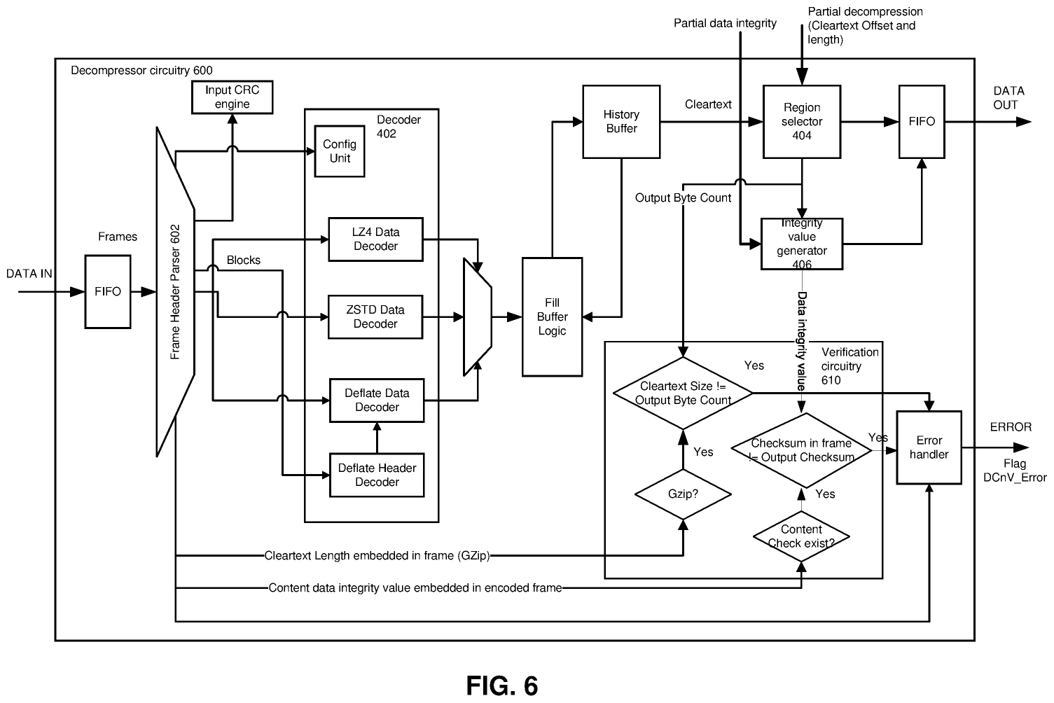

FIG. 6 depicts an example system. Decoder 402 can decode compressed data according to a compression format of the compressed data and output clear text data to region selector 404. Region selector 404 can output a count (e.g., bytes) of decompressed data to verification circuitry 610. Based on a mode of operation being full data decompression (e.g., not partial decompression), region selector 404 can output decompressed data to integrity value generator 406, to generate an data integrity value for the decompressed data. Region selector 404 can output a generated data integrity value for the decompressed data to verification circuitry 610. However, decompressor circuitry 600 can perform verification operations for partial decompressed data (e.g., a strict subset of decompressed data).

Parser 602 can detect the compressed data frame format and locate the data integrity value and data length fields in a compressed data and provide the data integrity value and data length to verification circuitry 610. In some examples, as described herein, parser 602 can determine a data compression format of input data frame/block by inspecting the compressed data frame format code. Based on compression frame format, parser 602 can identify compressed data's data integrity value and decompressed data (cleartext) length. Verification circuitry 610 can compare the provided data integrity value and data length from parser 602 with data integrity value and data length from respective integrity value generator 406 and region selector 404. Based on a match between the data integrity value and compression format specific values (e.g., data length) from respective integrity value generator 406 and region selector 404 and data integrity value and data length from parser 602, verification circuitry 610 can indicate a pass (e.g., Flag DCnV_Error=false) to indicate the data integration of decompressed data (cleartext) is validated. Based on a mismatch between the data integrity value or data length from respective integrity value generator 406 and region selector 404 and respective data integrity value or data length from parser 602, verification circuitry 610 can indicate a fail (e.g., Flag DCnV_Error=true) or an error code to indicate if the data integration of decompressed data (cleartext) is not validated. A firmware or driver of decompressor circuitry 600 can report the flag or error code. An application can rely on this flag or error code to determine integrity of data or decompression circuitry 600 for decompressing the data.

While examples are described with respect to verification of decryption operations, in some examples, verification of decryption of data can be performed based on a call to an API. The flag or error code can be provided to the requester to indicate if the decryption circuitry's output data is verified.

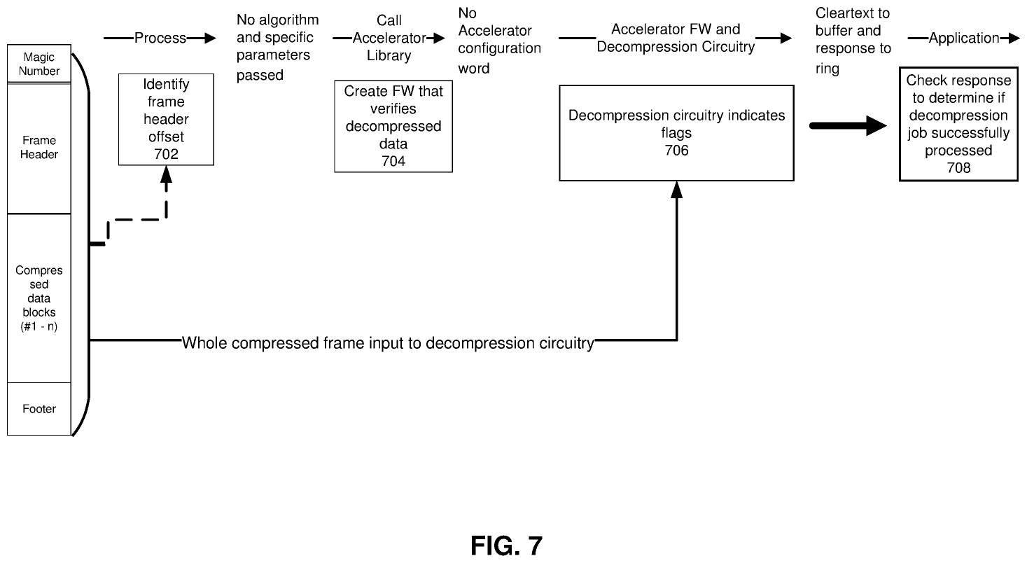

FIG. 7 depicts an example process. At 702, a process can identify a frame header offset in a compressed data frame that identifies a frame format of the compressed data. The process can include one or more of: an application, virtual machine (VM), container, microVM, microservice, or other software. Without passing a compression algorithm or parameters (e.g., block maximum size, block checksum flag) to an accelerator library, at 704, an accelerator library, accessed by the process, can create a firmware (FW) request to an accelerator firmware with decompression capabilities without providing a configuration word (e.g., compression algorithm, block maximum size, block checksum flag, block independent flag) to configure the accelerator. Decompression circuitry can parse the frame format code and frame header to identify the data compression type and parameters (e.g., block maximum size, block checksum flag, block independent flag) and convert them to configuration word and configure decompression and error checking based on the compression type and parameters.

At 706, the accelerator can perform decompression of data and indicate a flag of error or no error based on comparison of compression type, data integrity value, and length field from the compressed data frame against a data integrity value and length field generated from decompressing the compressed data frame. For example, the accelerator can compare the checksums (e.g., checksums based on gzip/Deflate, snappy, LZ4, ZSTD, XP10, or others) and cleartext length with those generated during decompression. At 708, an application can receive a report flag or error code directly from decompression circuitry without performing data integrity value or data length comparisons.

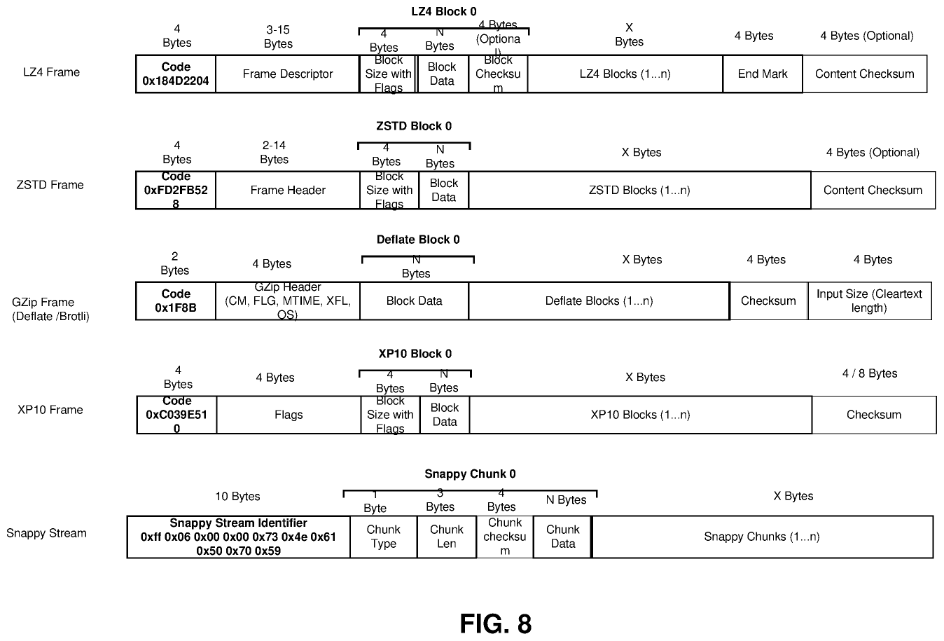

FIG. 8 depicts an example of frame formats. A frame format code in a compressed data frame can indicate a type of compression applied. Based on the type of compression applied, locations and lengths of the data integrity value (e.g., checksum) and frame length in the data frames can be identified and read by an accelerator to determine whether an error has occurred during decompression of the compressed data frames.

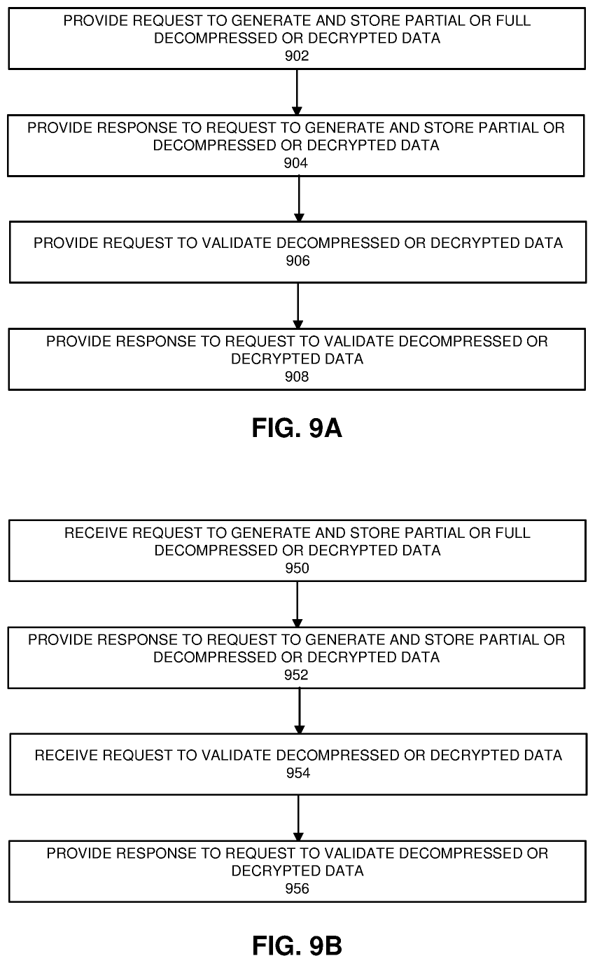

FIG. 9A depicts an example process. The process can be performed at least by a requester process, operating system, or device driver. At 902, a request can be issued to an accelerator to perform partial or full data decompression or decryption. For example, the accelerator can be capable of performing at least data encryption, data decryption, data compression, or data decompression. In response to the request to perform full data decompression or decryption, the accelerator can store an entirety of the decompressed data or decrypted data into a destination buffer in memory. In response to the request to perform partial data decompression or decryption, the accelerator can store less than an entirety of the decompressed data or decrypted data into a destination buffer in memory. At 904, a response can be received indicating completion of the request to perform partial or full data decompression or decryption, or an indication of error that the decompression or decryption operation failed.

At 906, a request can be issued to the accelerator to validate partial or full data decompression or decryption operations performed by the accelerator. At 908, a response to the request to validate partial or full data decompression or decryption operations can be received from the accelerator. The response can include a flag indicating whether the partial or full data decompression or decryption operations passed or failed. The response can be based on comparison of length and data integrity values in compressed or encrypted data against length and data integrity values generated from decompressed or decrypted values.

FIG. 9B depicts an example process. The process can be performed by an accelerator circuitry. At 950, a request can be received to perform partial or full data decompression or decryption. In response to the request to perform full data decompression or decryption, the accelerator can decompress or decrypt data and can store an entirety of the decompressed data or decrypted data into a destination buffer in memory. In response to the request to perform partial data decompression or decryption, the accelerator can decompress or decrypt data and can store less than an entirety of the decompressed data or decrypted data into a destination buffer in memory. At 952, a response can be provided indicating completion of the request to perform partial or full data decompression or decryption, or an indication of error that the decompression or decryption operation failed.

At 954, a request can be received to validate partial or full data decompression or decryption operations performed by the accelerator. At 956, a response can be provided to the request to validate partial or full data decompression or decryption operations. The response can include a flag indicating whether the partial or full data decompression or decryption operations passed or failed. The response can be based on comparison of length and data integrity values in compressed or encrypted data against length and data integrity values generated from decompressed or decrypted values.

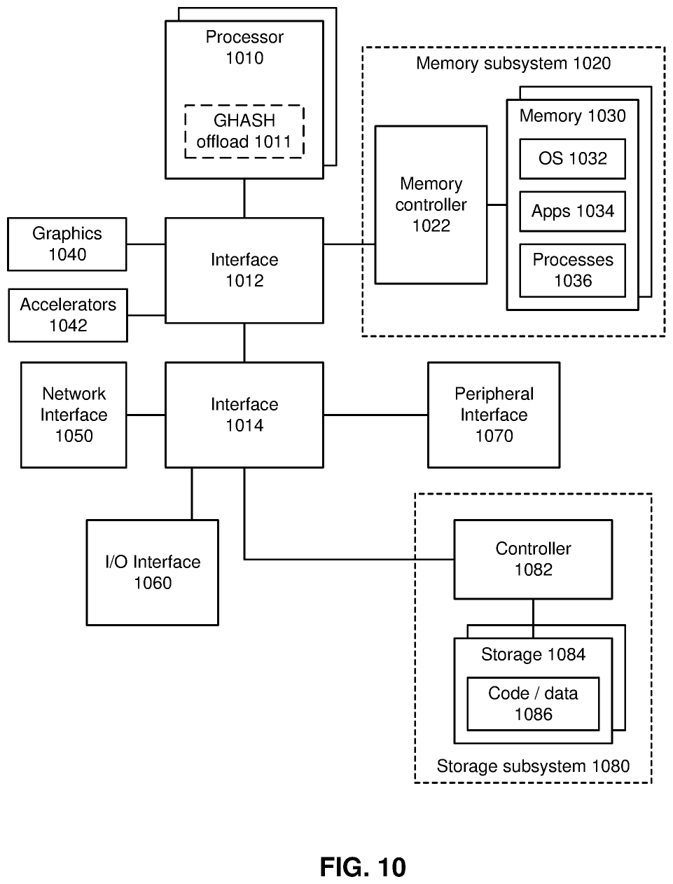

FIG. 10 depicts a system. The system can use examples to decompress or decrypt data and store an entirety of decompressed or decrypted data or a strict subset of decompressed or decrypted data or validate decompression or decryption operations, as described herein. In some examples, processor 1010, graphics 1040, one or more of accelerators 1042, and/or network interface 1050 can decompress or decrypt data and store an entirety of decompressed or decrypted data or a strict subset of decompressed or decrypted data or validate decompression or decryption operations, described herein. System 1000 includes processor 1010, which provides processing, operation management, and execution of instructions for system 1000. Processor 1010 can include any type of microprocessor, central processing unit (CPU), graphics processing unit (GPU), processing core, or other processing hardware to provide processing for system 1000, or a combination of processors. Processor 1010 controls the overall operation of system 1000, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 1000 includes interface 1012 coupled to processor 1010, which can represent a higher speed interface or a high throughput interface for system components that needs higher bandwidth connections, such as memory subsystem 1020 or graphics interface components 1040, or accelerators 1042. Interface 1012 represents an interface circuit, which can be a standalone component or integrated onto a processor die.

Accelerators 1042 can be a fixed function or programmable offload engine that can be accessed or used by a processor 1010. For example, an accelerator among accelerators 1042 can provide compression (DC) capability, cryptography services such as public key encryption (PKE), cipher, hash/authentication capabilities, decryption, or other capabilities or services. In some cases, accelerators 1042 can be integrated into a CPU socket (e.g., a connector to a motherboard or circuit board that includes a CPU and provides an electrical interface with the CPU). For example, accelerators 1042 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 1042 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 1020 represents the main memory of system 1000 and provides storage for code to be executed by processor 1010, or data values to be used in executing a routine. Memory subsystem 1020 can include one or more memory devices 1030 such as read-only memory (ROM), flash memory, one or more varieties of random access memory (RAM) such as static random-access memory (SRAM), dynamic random-access memory (DRAM), or other memory devices, or a combination of such devices. Memory 1030 stores and hosts, among other things, operating system (OS) 1032 to provide a software platform for execution of instructions in system 1000. Additionally, applications 1034 can execute on the software platform of OS 1032 from memory 1030. Applications 1034 represent programs that have their own operational logic to perform execution of one or more functions. Processes 1036 represent agents or routines that provide auxiliary functions to OS 1032 or one or more applications 1034 or a combination. OS 1032, applications 1034, and processes 1036 provide software logic to provide functions for system 1000. In one example, memory subsystem 1020 includes memory controller 1022, which is a memory controller to generate and issue commands to memory 1030. It will be understood that memory controller 1022 could be a physical part of processor 1010 or a physical part of interface 1012. For example, memory controller 1022 can be an integrated memory controller, integrated onto a circuit with processor 1010.

In some examples, OS 1032 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a CPU sold or designed by Intel®, ARM®, AMD®, Qualcomm®, IBM®, Texas Instruments®, among others.

While not specifically illustrated, it will be understood that system 1000 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 1000 includes interface 1014, which can be coupled to interface 1012. In one example, interface 1014 represents an interface circuit, which can include standalone components and integrated circuitry. In one example, multiple user interface components or peripheral components, or both, couple to interface 1014. Network interface 1050 provides system 1000 the ability to communicate with remote devices (e.g., servers or other computing devices) over one or more networks. In some examples, network interface 1050 can refer to one or more of: a network interface controller (NIC), a remote direct memory access (RDMA)-enabled NIC, SmartNIC, router, switch, forwarding element, infrastructure processing unit (IPU), data processing unit (DPU), or network-attached appliance.

Network interface 1050 can include an Ethernet adapter, wireless interconnection components, cellular network interconnection components, USB (universal serial bus), or other wired or wireless standards-based or proprietary interfaces. Network interface 1050 can transmit data to a device that is in the same data center or rack or a remote device, which can include sending data stored in memory.

Some examples of network interface 1050 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Some examples of network interface 1050 can include a programmable packet processing pipeline with one or multiple consecutive stages of match-action circuitry. The programmable packet processing pipeline can be programmed using one or more of: Protocol-independent Packet Processors (P4), Software for Open Networking in the Cloud (SONiC), Broadcom® Network Programming Language (NPL), NVIDIA® CUDA®, NVIDIA® DOCA™ Data Plane Development Kit (DPDK), OpenDataPlane (ODP), Infrastructure Programmer Development Kit (IPDK), x86 compatible executable binaries or other executable binaries, or others.

In one example, system 1000 includes one or more input/output (I/O) interface(s) 1060. I/O interface 1060 can include one or more interface components through which a user interacts with system 1000 (e.g., audio, alphanumeric, tactile/touch, or other interfacing). Peripheral interface 1070 can include any hardware interface not specifically mentioned above. Peripherals refer generally to devices that connect dependently to system 1000. A dependent connection is one where system 1000 provides the software platform or hardware platform or both on which operation executes, and with which a user interacts.

In one example, system 1000 includes storage subsystem 1080 to store data in a nonvolatile manner In one example, in certain system implementations, at least certain components of storage 1080 can overlap with components of memory subsystem 1020. Storage subsystem 1080 includes storage device(s) 1084, which can be or include any conventional medium for storing large amounts of data in a nonvolatile manner, such as one or more magnetic, solid state, or optical based disks, or a combination. Storage 1084 holds code or instructions and data 1086 in a persistent state (e.g., the value is retained despite interruption of power to system 1000). Storage 1084 can be generically considered to be a “memory,” although memory 1030 is typically the executing or operating memory to provide instructions to processor 1010. Whereas storage 1084 is nonvolatile, memory 1030 can include volatile memory (e.g., the value or state of the data is indeterminate if power is interrupted to system 1000). In one example, storage subsystem 1080 includes controller 1082 to interface with storage 1084. In one example controller 1082 is a physical part of interface 1014 or processor 1010 or can include circuits or logic in both processor 1010 and interface 1014.

A volatile memory is memory whose state (and therefore the data stored in it) is indeterminate if power is interrupted to the device. A non-volatile memory (NVM) device is a memory whose state is determinate even if power is interrupted to the device.

In an example, system 1000 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

Communications between devices can take place using a network, interconnect, or circuitry that provides chipset-to-chipset communications, die-to-die communications, packet-based communications, communications over a device interface (e.g., PCIe, CXL, UPI, or others), fabric-based communications, and so forth. A die-to-die communications can be consistent with Embedded Multi-Die Interconnect Bridge (EMIB).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner, or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal (e.g., active-low or active-high). The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”’

Illustrative examples of the devices, systems, and methods disclosed herein are provided below. An embodiment of the devices, systems, and methods may include any one or more, and any combination of, the examples described below.

Example 1 includes an apparatus that includes an accelerator comprising: an interface and circuitry coupled to the interface, the circuitry configured to access compressed data, decompress the compressed data, and output the decompressed data based on a call to an application programming interface (API), wherein: based on a first call to the API having first values, the circuitry is to decompress at least a subset of the data and output at least one strict subset of the decompressed data and based on a second call to the API having second values, the circuitry is to decompress an entirety of the data and output the decompressed data.

Example 2 includes one or more examples, wherein the first call to the API is to specify one or more of: a command to output a strict subset of the decompressed data, an offset from a start of a buffer to a start of the at least one strict subset of the decompressed data, an offset from a start of at least one strict subset of the compressed data to commence decompression, a length of decompressed data, or a length of the at least one strict subset of the compressed data.

Example 3 includes one or more examples, wherein based on the first call to the API, the circuitry is to generate a data integrity check value based on the at least one strict subset of the decompressed data.

Example 4 includes one or more examples, wherein based on the second call to the API, the circuitry is to generate a data integrity check value based on an entirety of the decompressed data.

Example 5 includes one or more examples, wherein based on a command, the circuitry is to: verify that a first value of the data compressed by the circuitry is decompressed into the first value and output a value indicative of a match or non-match.

Example 6 includes one or more examples, wherein the accelerator comprises circuitry to perform encryption, decryption, and compression operations on data based on the API.

Example 7 includes one or more examples, wherein a process is to issue the first call to the API and the second call to the API.

Example 8 includes one or more examples, and includes at least one non-transitory computer-readable medium comprising instructions, that if executed by one or more processors, cause the one or more processors to: issue a first call to an application program interface (API) to an accelerator to cause the accelerator to decompress data and output at least one strict subset of the decompressed data and issue a second call to the API to the accelerator to cause the accelerator to decompress an entirety of the data and output the decompressed data.

Example 9 includes one or more examples, wherein the first call to the API is to specify one or more of: a command to output a strict subset of the decompressed data, an offset from a start of a buffer to a start of the at least one strict subset of the decompressed data, or a length of decompressed data.

Example 10 includes one or more examples, wherein based on the first call to the API, the accelerator is to generate a data integrity check value based on the at least one strict subset of the decompressed data.

Example 11 includes one or more examples, wherein based on the second call to the API, the accelerator is to generate a data integrity check value based on an entirety of the decompressed data.

Example 12 includes one or more examples, comprising instructions, that if executed by one or more processors, cause the one or more processors to: issue a command to cause the accelerator to verify that a first value of second data compressed by the accelerator is decompressed into the first value and output a value indicative of a match or non-match.

Example 13 includes one or more examples, wherein the accelerator comprises circuitry to perform encryption, decryption, and compression operations on data based on received calls to the API.

Example 14 includes one or more examples, wherein the instructions comprise a virtual machine or an operating system (OS).

Example 15 includes one or more examples, and includes a method comprising: based on a first call to an application program interface (API), an accelerator decompressing data and outputting at least one strict subset of the decompressed data and based on a second call to the API, the accelerator decompressing an entirety of the data and output the decompressed data.

Example 16 includes one or more examples, wherein the first call to the API specifies one or more of: a command to output a strict subset of the decompressed data, an offset from a start of a buffer to a start of the at least one strict subset of the decompressed data, or a length of decompressed data.

Example 17 includes one or more examples, comprising: based on the first call to the API, the accelerator generating a data integrity check value based on the at least one strict subset of the decompressed data.

Example 18 includes one or more examples, comprising: based on the second call to the API, the accelerator generating a data integrity check value based on an entirety of the decompressed data.

Example 19 includes one or more examples, comprising: based on a command, the accelerator verifying that a first value of the data compressed by the accelerator is decompressed into the first value and output a value indicative of a match or non-match.

Example 20 includes one or more examples, wherein the accelerator comprises circuitry to perform encryption, decryption, and compression operations on data based on received calls to the APIs.

1. An apparatus comprising:
an accelerator comprising:
an interface and
circuitry coupled to the interface, the circuitry configured to access compressed data, decompress the compressed data, and output the decompressed data based on a call to an application programming interface (API), wherein:
based on a first call to the API having first values, the circuitry is to decompress at least a subset of the data and output at least one strict subset of the decompressed data and
based on a second call to the API having second values, the circuitry is to decompress an entirety of the data and output the decompressed data.

2. The apparatus of claim 1, wherein the first call to the API is to specify one or more of: a command to output a strict subset of the decompressed data, an offset from a start of a buffer to a start of the at least one strict subset of the decompressed data, an offset from a start of at least one strict subset of the compressed data to commence decompression, a length of decompressed data, or a length of the at least one strict subset of the compressed data.

3. The apparatus of claim 1, wherein based on the first call to the API, the circuitry is to generate a data integrity check value based on the at least one strict subset of the decompressed data.

4. The apparatus of claim 1, wherein based on the second call to the API, the circuitry is to generate a data integrity check value based on an entirety of the decompressed data.

5. The apparatus of claim 1, wherein based on a command, the circuitry is to:
verify that a first value of the data compressed by the circuitry is decompressed into the first value and output a value indicative of a match or non-match.

6. The apparatus of claim 1, wherein the accelerator comprises circuitry to perform encryption, decryption, and compression operations on data based on the API.

7. The apparatus of claim 1, wherein a process is to issue the first call to the API and the second call to the API.

8. At least one non-transitory computer-readable medium comprising instructions, that if executed by one or more processors, cause the one or more processors to:
issue a first call to an application program interface (API) to an accelerator to cause the accelerator to decompress data and output at least one strict subset of the decompressed data and
issue a second call to the API to the accelerator to cause the accelerator to decompress an entirety of the data and output the decompressed data.

9. The computer-readable medium of claim 8, wherein the first call to the API is to specify one or more of: a command to output a strict subset of the decompressed data, an offset from a start of a buffer to a start of the at least one strict subset of the decompressed data, or a length of decompressed data.

10. The computer-readable medium of claim 8, wherein based on the first call to the API, the accelerator is to generate a data integrity check value based on the at least one strict subset of the decompressed data.

11. The computer-readable medium of claim 8, wherein based on the second call to the API, the accelerator is to generate a data integrity check value based on an entirety of the decompressed data.

12. The computer-readable medium of claim 8, comprising instructions, that if executed by one or more processors, cause the one or more processors to:
issue a command to cause the accelerator to verify that a first value of second data compressed by the accelerator is decompressed into the first value and output a value indicative of a match or non-match.

13. The computer-readable medium of claim 8, wherein the accelerator comprises circuitry to perform encryption, decryption, and compression operations on data based on received calls to the API.

14. The computer-readable medium of claim 8, wherein the instructions comprise a virtual machine or an operating system (OS).

15. A method comprising:
based on a first call to an application program interface (API), an accelerator decompressing data and outputting at least one strict subset of the decompressed data and
based on a second call to the API, the accelerator decompressing an entirety of the data and output the decompressed data.

16. The method of claim 15, wherein the first call to the API specifies one or more of: a command to output a strict subset of the decompressed data, an offset from a start of a buffer to a start of the at least one strict subset of the decompressed data, or a length of decompressed data.

17. The method of claim 15, comprising:
based on the first call to the API, the accelerator generating a data integrity check value based on the at least one strict subset of the decompressed data.

18. The method of claim 15, comprising:
based on the second call to the API, the accelerator generating a data integrity check value based on an entirety of the decompressed data.

19. The method of claim 15, comprising:
based on a command, the accelerator verifying that a first value of the data compressed by the accelerator is decompressed into the first value and output a value indicative of a match or non-match.

20. The method of claim 15, wherein the accelerator comprises circuitry to perform encryption, decryption, and compression operations on data based on received calls to the APIs.
